(19) United States
(12) Patent Application Publication
(10) Pub. No.: US 2014/0322693 A1
(43) Pub. Date: Oct. 30, 2014

(54) Student-to-Student Assistance in a Blended Learning Curriculum

(71) Applicant: Steven Sounyoung Yu, Rockville, MD (US)

(72) Inventor: Steven Sounyoung Yu, Rockville, MD (US)

(21) Appl. No.: 14/265,325

(22) Filed: Apr. 29, 2014

Related U.S. Application Data
(60) Provisional application No. 61/817,847, filed on Apr. 30, 2013.

(51) Int. Cl. G09B 5/14

(52) U.S. Cl. CPC G09B 5/14
USPC 434/350

(57) ABSTRACT

A method of providing primary and/or secondary education using a blended learning curriculum. The method is implemented in a school comprising students of mixed-age and/or mixed-grade level. The students are provided with a curriculum that combines machine-guided teaching with face-to-face teaching. One or more of the senior students assist one or more of the junior students with the machine-guided teaching.

### CROSS-REFERENCES

This application claims the benefit of U.S. Provisional Application Ser. No. 61/817,847 (filed 30 Apr. 2013), which is incorporated by reference herein.

### TECHNICAL FIELD

The present invention relates to education systems for primary and/or secondary schools.

### BACKGROUND

In a school that uses a blended learning (also called hybrid learning) curriculum, face-to-face classroom methods are combined with computer-mediated activities. Blended learning provides the benefits of online learning within a physical building. This has many advantages, including allowing students work at a customized level and pace, instead of moving through school in age-based cohorts regardless of their comprehension, providing multiple learning modalities, giving students ownership and control of their education, and empowering teachers to better track an individual student's progress.

While there is a face-to-face element of blended learning, students still spend much of their time sitting in front of a computer. There is a need to provide a more human-interactive approach to blended learning, that allows more group projects, small or large group instruction, one-on-one tutoring, and/or direct supervision of students in a cost-effective manner.

### SUMMARY

The present invention recognizes that not all the tasks in classroom management requires the intervention of a teacher. In particular, because at least a part of the subject matter content is delivered through the machine-guided teaching, some of the ancillary tasks performed by a teacher in managing her students may be performed by someone else. In one embodiment, the present invention provides a method of providing primary and/or secondary education. The method is implemented in a school comprising students of mixed-age and/or mixed-grade level. The students are provided with a curriculum that, at least in part, combines machine-guided teaching with face-to-face teaching. One or more of the senior students assist one or more of the junior students with the machine-guided teaching.

In another embodiment, the present invention provides a primary and/or secondary school comprising students of mixed-age and/or mixed-grade level. The school uses a curriculum that, at least in part, combines machine-guided teaching with face-to-face teaching. One or more of the senior students assist one or more of the junior students with the machine-guided teaching.

In another embodiment, the present invention provides a method of educating students in a school, comprising providing educational services to a primary and/or secondary school of the present invention. This may include, for example, providing online content, hardware, software, electronic media, consulting services, technical support, books, worksheets, teachers, and/or teacher training to a school that uses the method of the present invention. The content of the machine-guided teaching may be specifically adapted to implement the student-to-student assistance of the present invention.

In another embodiment, the present invention can be used with a residential housing complex as described in U.S. application Ser. No. 13/792,203 (filed 11 Mar. 2013), which is incorporated by reference herein. The present invention can be implemented in the school of the residential housing complex.

### BRIEF DESCRIPTION OF THE DRAWINGS

FIG. 1 shows an older student assisting several younger students who are each engaged individually in a machine-guided teaching lesson.

FIG. 2 shows two fourth grade students assisting a small group of second grade students who are engaged in a machine-guided group teaching exercise using an electronic white board.

FIG. 3 shows an example of students rotating through three learning activities A, B, and C, each using a different learning modality.

### DETAILED DESCRIPTION

The present invention provides a method of teaching primary and/or secondary school education using a combination of machine-guided teaching and face-to-face teaching by an in-person teacher. The machine-guided teaching may be implemented using any suitable machine for interacting with students, including computers (e.g. desktop, laptop, or tablet), robots, and interactive display systems. The machine-guided teaching curriculum may be online (e.g. Web-based) or offline (e.g., from installed software, CDs, DVDs, etc). The machine-guided teaching can be implemented to give students some degree of control over the time, place, path, and/or pace of the delivery of the teaching. Examples of such types of teaching methods include hybrid online learning or blended learning techniques that combine traditional face-to-face teaching with online learning.

The machine-guided teaching can constitute any suitable portion of the curriculum. In some embodiments, the machine-guided teaching provides at least 30% of the student didactic instruction (the time used for listening and/or watching didactic, instructional material; but not counting the time for non-didactic activities such as group activities or projects, playtime or recess, science labs, live demonstrations, and other experiential learning activities) instead of an in-person teacher; in some cases, at least 40% of the student didactic instruction time; in some cases, at least 50% of the student didactic instruction time. In the face-to-face teaching, the teaching activity can be performed in any suitable setting, such as small-group or full-class instruction, group projects, individual tutoring, or pencil-and-paper assignments

The method further comprises having a senior student assist a junior student in the use of the machine-guided teaching. A “senior student” means a student who is higher in grade level and/or older in age relative to the “junior student.” In some embodiments, the senior student is at least one grade level higher and/or at least one year older than the junior student; in some cases, at least two grade levels higher and/or at least two years older; in some cases, at least three grade levels higher and/or at least three years older; and in some cases, at least four grade levels higher and/or at least four years older than the junior student.

Because older or higher grade level students may not need this type of assistance in their use of the machine-guided teaching, in some embodiments, this student-to-student assistance may be provided only to students who are relatively younger and/or in lower grade levels. For example, an 8th grader may be self-sufficient in using the machine-guided teaching and may not need this type of assistance. As such, use of the present invention may be limited, with respect to the junior students, to those at an age or grade level needing more assistance with machine-guided learning. In some embodiments, the junior students receiving the student-to-student assistance are not higher than 7th grade level and/or not older than 13 years age, i.e., they are within the range of 7th grade or lower and/or 13 years old or younger. For example, the present invention can be implemented with only students in grade levels 1-5 receiving the student-to-student assistance (as the junior students being within the range of 7th grade or lower).

In some cases, the junior students receiving the student-to-student assistance are not higher than 6th grade level and/or not older than 12 years age, i.e., they are within the range of 6th grade or lower and/or 12 years old or younger; in some cases, the junior students are not higher than 5th grade level and/or not older than 11 years age, i.e., they are within the range of 5th grade or lower and/or 11 years old or younger. But this does not necessarily limit the grade level and/or age for the senior students who are providing the assistance. For example, the present invention can be implemented with only students in grade levels K-4 receiving the student-to-student assistance, which can be provided by more senior students in grade levels 6-9.

Because relatively older or higher grade level students are more likely to have the requisite authority and maturity to provide assistance to the junior students, in some embodiments, only senior students who are relatively older and/or in higher grade levels may provide the student-to-student assistance to the junior students. In some embodiments, the senior students providing the assistance to the junior students are at least 2nd grade level and/or at least 7 years age, i.e., they are within the range of 2nd grade level or higher and/or 7 years age or older. For example, the present invention can be implemented with only students in grade levels 4-8 being the senior students that provide the assistance to the junior students.

As used herein, “assisting” means that the senior student is guiding, coaching, supervising, overseeing, etc., the junior student in the use of the machine-guided teaching. Examples of “assisting” include navigating the machine interface, ensuring that the student is engaged with the lesson (e.g. not playing games), encouraging the student, answering questions, or attending to technical problems with the teaching machine. The senior student may or may not also provide some teaching of the subject material to the junior student. However, this is not necessary to implement the present invention.

In any case, the teaching of the subject material will be performed primarily by the machine-guided teaching and/or an adult teacher (in-person). The present invention is not intended to have the senior student assume primary responsibility for directly teaching the subject material to the junior student. Also, this student-to-student interaction is not intended to be a collaborative learning activity in which both the junior student and the senior student collaborate with each other to learn the same subject material. In some embodiments, at least 50% of time spent by the senior student in “assisting” the junior student is not direct teaching of the subject material and not engaging in learning of the same subject material being taught to the junior student; in some cases, at least 70% of time spent; in some cases, at least 80% of time spent; in some cases, at least 90% of time spent by the senior student in “assisting” the junior student is not direct teaching of the subject material and not engaging in learning of the same subject material being taught to the junior student.

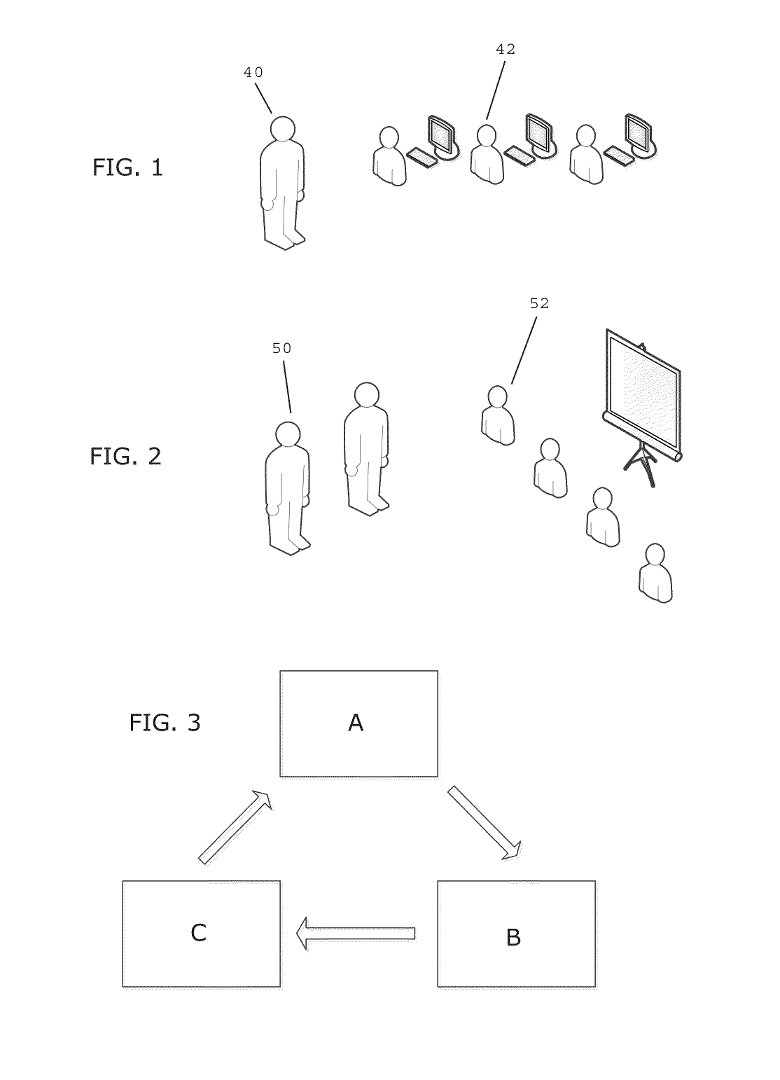

There may be more than one of the senior students and/or more than one of the junior students in the student-to-student interaction groups. For example, a single senior student can assist a single junior student, or multiple (two or more) senior students can assist a single junior student, or a single senior student can assist multiple junior students, or multiple senior students can assist multiple junior students. In another example, FIG. 1 shows a single 8-year old student 40 assisting several 5-6 year old students 42 who are each engaged individually in a machine-guided teaching lesson. FIG. 2 shows two fourth graders 50 assisting a small group of second graders 52 who are engaged in a machine-guided group teaching exercise using an electronic white board.

There are various types of models of machine-guided teaching through which the present invention can be implemented. In some embodiments, the curriculum is provided according to a rotation model in which (at least) the junior students rotate through two or more different learning modalities, at least one of which uses machine-guided teaching with the student-to-student assistance, and another of which uses a different learning modality (e.g. with a teacher or teaching paraprofessional in small-group or full-class instruction, group projects, individual tutoring, or pencil-and-paper assignments).

The students can rotate through the different learning modalities in any suitable way, such as different activities at different sites (e.g. different classrooms), or different activities at the same site (e.g. same classroom), different activities on different days, all rotation activities on the same day, one-by-one rotations, small group rotations, entire class alternating among different activities together, or any other way in which a rotation model of blended learning can be implemented. In some cases, the machine-guided teaching with student-to-student assistance is used in at least one but not all the learning modalities in the rotation.

For example, FIG. 3 shows an example of students rotating through three learning activities A, B, and C, each using a different learning modality. In learning activity A, the students engage in individual machine-guided learning with assistance from a senior student. In learning activity B, the students engage in learning with the in-person teacher. In learning activity C, the students engage in a small group activity with a teacher or teaching paraprofessional.

Because the machine-guided teaching may be capable of supporting multiple grade levels, teachers may be assigned to teach multiple different grade levels as well. In some embodiments, there is at least one teacher in the school who teaches multiple (two or more) different grade levels. For example, a teacher may be responsible for teaching grade levels K-3 in the school. In some cases, there is at least one teacher in the school who teaches 3 or more different grade levels in the school; in some cases, 4 or more different grade levels; in some cases, 5 or more different grade levels in the school. In some cases, there may be at least two teachers in the school who teach multiple grade levels in this manner; and in some cases, at least three teachers who teach multiple grade levels in this manner.

Because the machine-guided teaching supports the in-person teacher with the subject material, this reduces the need for subject material specialization on the part of the teacher. In some embodiments, there is at least one teacher in the school who teaches multiple (two or more) different subject types (e.g. math, science, history, geography, English, etc.). For example, a teacher may be responsible for teaching both math and science. In some cases, there is at least one teacher in the school who teaches 3 or more different subject types in the school; in some cases, 4 or more different subjects types. In some cases, there may be at least two teachers in the school who teach multiple subjects in this manner; and in some cases, at least three teachers who teach multiple subjects in this manner.

A teacher who teaches multiple grade levels may also teach multiple subject types in any combination of the above described embodiments. For example, the school may have a teacher who teaches reading, history, and social studies for grade levels K-8; another teacher who teaches math and science for grade levels K-4; and another teacher who teaches math and science for grade levels 5-8.

By having students assist other students in the manner described herein, the number of adult teachers can be reduced and/or be given better pay or benefits. In some embodiments, the school may have 25 certified/licensed teachers or fewer; in some cases, 20 or fewer; in some cases, 15 or fewer; in some cases, 9 or fewer; in some cases, 5 or fewer certified/licensed teachers. In some embodiments, the school has a school-wide student to certified/licensed teacher ratio of 30 or more; in some cases, 35 or more; in some cases, 40 or more; in some cases, 45 or more; in some cases, 50 or more.

In some embodiments, the school has at least one teaching paraprofessional who is not certified/licensed (e.g. teaching assistant, teacher's aide, instructional assistant, classroom assistant, or other teaching-related position that assists the certified or licensed teacher); in some cases, at least two teaching paraprofessionals; in some cases, at least three teaching paraprofessionals; in some cases, at least five teaching paraprofessionals.

The school of the present invention has a real physical setting (i.e. is “brick-and-mortar,” not completely virtual). The school may be a public school (including charter schools, magnet schools, or other types of specialized public schools) or a private school (including independent schools). In some embodiments, the school has at least 50 students of mixed-age and/or mixed-grade level; in some cases, at least 100 students; in some cases, at least 200 students of mixed-age and/or mixed-grade level.

The school may include any or all primary school and/or secondary school grade levels, which may correspond with different terminologies in different parts of the United States, including K-12 grade levels, or preschool, kindergarten, elementary school (e.g. kindergarten and grade levels 1-5), middle school (e.g. grade levels 6-8), intermediate school, high school (e.g. grade levels 9-12), junior high school, and senior high school (e.g. grade levels 10-12). In some embodiments, the school includes at least grade level 1 or higher (e.g. grades K-6, grades 1-7, or grades 6-9); in some cases, at least grade level 2 or higher (e.g. grades 1-6 or grades 3-8); in some cases, at least grade level 3 or higher (e.g. grades levels 1-5 or grade levels 6-8).

Using the present invention can be beneficial in reducing the physical size of the school. In some embodiments, the school occupies a floor space of less than 120,000 sq. ft. (as net usable square feet); in some cases, less than 90,000 sq. ft.; in some cases, less than 75,000 sq. ft.; in some cases, less than 60,000 sq. ft.; in some cases, less than 50,000 sq. ft.; in some cases, less than 40,000 sq. ft.; in some cases, less than 30,000 sq. ft.; in some cases, less than 25,000 sq. ft.

Using the present invention can improve the academic performance of schools. As such, in some embodiments, the school is located in an area with academically low-performing public schools, is economically disadvantaged, and/or having overcrowded public schools. In the description of the present invention herein, such areas may be defined by school boundary, zip code, or census tract. For the purposes of understanding the present invention, the census tract is to be taken from the most recent U.S. Census. For example, in the year 2016, the census tracts used in the U.S. Census of 2010 should be applied. In another example, in the year 2022, the census tracts used in the U.S. Census of 2020 should be applied. In many jurisdictions or territories, residential areas are assigned to a school boundary containing one or more specific public schools that are assigned to the residences within that boundary. A school of the present invention may be located within such a school boundary.

In some embodiments, a school of the present invention is located in an area (defined by school boundary, zip code, and/or census tract) where at least one public school (e.g. high school) has a graduation rate (e.g. that is used to demonstrate Adequate Yearly Progress (AYP) under the No Child Left Behind Act of 2001) of less than 85% in four years; in some embodiments, less than 80%; in some embodiments, less than 75%; in some embodiments, less than 70%; in some embodiments, less than 60% in four years.

In some embodiments, a school of the present invention is located in an area (defined by school boundary, zip code, and/or census tract) where at least one public school (e.g. high school) has a mathematics SAT® score in the 75th percentile or below of national or state scores; in some embodiments, in the 70th percentile or below; in some embodiments, in the 65th percentile or below; in some embodiments, in the 60th percentile or below; in some embodiments, in the 55th percentile or below; in some embodiments, in the 50th percentile or below; in some embodiments, in the 45th percentile or below; in some embodiments, in the 40th percentile or below.

In some embodiments, a school of the present invention is located in an area (defined by school boundary, zip code, and/or census tract) where at least one public school (e.g. high school) has a combined SAT® score in the 75th percentile or below of national or state scores; in some embodiments, in the 70th percentile or below; in some embodiments, in the 65th percentile or below; in some embodiments, in the 60th percentile or below; in some embodiments, in the 55th percentile or below; in some embodiments, in the 50th percentile or below; in some embodiments, in the 45th percentile or below; in some embodiments, in the 40th percentile or below.

In some embodiments, a school of the present invention is located in an area (defined by school boundary, zip code, and/or census tract) where at least one public school (e.g. middle or high school) has less than 85% of the students meet or exceed the state or federal standards for mathematics proficiency; in some embodiments, less than 80%; in some embodiments, less than 75%; in some embodiments, less than 70%; in some embodiments, less than 65%; in some embodiments, less than 60%; in some embodiments, less than 55%; in some embodiments, less than 50%; in some embodiments, less than 45%; in some embodiments, less than 40%; in some embodiments, less than 35%. An example of such a standard are each state's standards for mathematics and reading/language arts proficiency used to demonstrate Adequate Yearly Progress (AYP) under the No Child Left Behind Act of 2001. State standards are publicly available from various known sources, including government sources.

In some embodiments, a school of the present invention is located in an area (defined by school boundary, zip code, and/or census tract) where at least one public school (e.g. middle or high school) has less than 85% of the students meet or exceed the state or federal standards for reading proficiency; in some embodiments, less than 80%; in some embodiments, less than 75%; in some embodiments, less than 70%; in some embodiments, less than 65%; in some embodiments, less than 60%; in some embodiments, less than 55%; in some embodiments, less than 50%; in some embodiments, less than 45%; in some embodiments, less than 40%; in some embodiments, less than 35%. An example of such a standard are each state's standards for mathematics and reading/language arts proficiency used to demonstrate Adequate Yearly Progress (AYP) under the No Child Left Behind Act of 2001. State standards are publicly available from various known sources, including government sources.

In some embodiments, a school of the present invention is located in an area (defined by school boundary, zip code, and/or census tract) where at least one public school (e.g. middle or high school) has a GreatSchools™ (www.greatschools.org) rating of 6 or lower; in some embodiments, 5 or lower; in some embodiments, 4 or lower; in some embodiments, 3 or lower.

In some embodiments, a school of the present invention is located in an area (defined by school boundary, zip code, and/or census tract) where at least one public school (e.g. elementary, middle, or high school) has at least 25% of the students in a free or reduced-price meals program; in some embodiments, at least 30%; in some embodiments, at least 35%; in some embodiments, at least 40% of the students.

In some embodiments, a school of the present invention is located in an area (defined by school boundary, zip code, and/or census tract) where at least one public school (e.g. elementary, middle, or high school) is over capacity. For example, the public school may be more than 20% over capacity (i.e. 20% more than the number of students that the school was designed or built to serve); in some cases, more than 25% over capacity; in some cases, more than 50% over capacity; and in some cases, more than 100% over capacity. Other indications of school overcrowding may be use of temporary classrooms, such as trailers or other “portables”; conversion of gymnasiums, libraries, teachers' workrooms, and/or storage areas into classrooms; adoption of multi-track schedules where students and teachers rotate being in school and on vacation at different times during the year.

The school may be located in an area with relatively higher population density (e.g. within cities or inner suburbs around cities). For example, the school of the present invention may be located within a zip code and/or census tract having a population density of greater than 1,500 people per square mile; in some embodiments, greater than 2,000; in some embodiments, greater than 2,500; in some embodiments, greater than 3,000; in some embodiments, greater than 4,000; in some embodiments, greater than 5,000; in some embodiments, greater than 7,000 people per square mile.

By reducing the cost of operating a school, the present invention can be useful in areas where the cost of operating a school is relatively higher (whether public or private schools). The school may be located within or near a major city. In some embodiments, a school of the present invention is located in or within 15 miles of the border of a city having a population of at least 350,000 people; in some embodiments, at least 500,000 people; in some embodiments, at least 750,000 people; in some embodiments, at least 1,000,000 people. In some embodiments, the residential complex is located in one of the following cities or within 15 miles of the border of one of the following cities: New York, N.Y.; Los Angeles, Calif.; Chicago, Ill.; Houston, Tex.; Philadelphia, Pa.; Phoenix, Ariz.; San Diego, Calif.; San Antonio, Tex.; Dallas, Tex.; Detroit, Mich.; San Jose, Calif.; Indianapolis, Ind.; Jacksonville, Fla.; San Francisco, Calif.; Columbus, Ohio; Austin, Tex.; Memphis, Tenn.; Baltimore, Md.; Charlotte, N.C.; Fort Worth, Tex.; Boston, Mass.; Milwaukee, Wis.; El Paso, Tex.; Washington, D.C.; Nashville-Davidson, Tenn.; Seattle, Wash.; Denver, Colo.; Las Vegas, Nev.; Portland, Oreg.; Oklahoma City, Okla.; Tucson, Ariz.; Albuquerque, N. Mex.; Atlanta, Ga.; Long Beach, Calif.; Kansas City, Mo.; Fresno, Calif.; New Orleans, La.; Cleveland, Ohio; Sacramento, Calif.; Mesa, Ariz.; Virginia Beach, Va.; Omaha, Nebr.; Colorado Springs, Colo.; Oakland, Calif.; Miami, Fla.; Tulsa, Okla.; Minneapolis, Minn.; Honolulu, Hi.; Arlington, Tex.; Wichita, Kans.; St. Louis, Mo.; Raleigh, N.C.; Santa Ana, Calif.; Cincinnati, Ohio; Anaheim, Calif.; Tampa, Fla.; Toledo, Ohio; Pittsburgh, Pa.; Aurora, Colo.; Bakersfield, Calif.; Riverside, Calif.; Stockton, Calif.; Corpus Christi, Tex.; Lexington-Fayette, Ky.; Buffalo, N.Y.; St. Paul, Minn.; Anchorage, Ak.; Newark, N.J.; Plano, Tex.; Fort Wayne, Ind.; St. Petersburg, Fla.; Glendale, Ariz.; Lincoln, Nebr.; Norfolk, Va.; Jersey City, N.J.; Greensboro, N.C.; Chandler, Ariz.; Birmingham, Ala.; Henderson, Nev.; Scottsdale, Ariz.; North Hempstead, N.Y.; Madison, Wis.; Hialeah, Fla.; Baton Rouge, La.; Chesapeake, Va.; Orlando, Fla.; Lubbock, Tex.; Garland, Tex.; Akron, Ohio; Rochester, N.Y.; Chula Vista, Calif.; Reno, Nev.; Laredo, Tex.; Durham, N.C.; Modesto, Calif.; Huntington, N.Y.; Montgomery, Ala.; Boise, Id.; Arlington, Va.; San Bernardino, Calif.

As used herein, “state” means one of the 50 states in the United States of America or the District of Columbia. A listing of the 50 states is as follows: Alabama, Alaska, Arizona, Arkansas, California, Colorado, Connecticut, Delaware, Florida, Georgia, Hawaii, Idaho, Illinois, Indiana, Iowa, Kansas, Kentucky, Louisiana, Maine, Maryland, Massachusetts, Michigan, Minnesota, Mississippi, Missouri, Montana, Nebraska, Nevada, New Hampshire, New Jersey, New Mexico, New York, North Carolina, North Dakota, Ohio, Oklahoma, Oregon, Pennsylvania, Rhode Island, South Carolina, South Dakota, Tennessee, Texas, Utah, Vermont, Virginia, Washington, West Virginia, Wisconsin, and Wyoming.

By having students assist other students in this manner, the present invention has the synergistic effect of allowing the operation of a school with fewer teachers (thus reducing costs), while also improving the education of students. The junior student will, of course, benefit from the assistance provided by the senior student. The senior students can benefit from their practice of leadership skills and reinforcing their own knowledge of the subject matter.

Implementing the present invention does not require that the machine-guided teaching with student-to-student assistance be used for all the students in the school, for the entire curriculum, for all grade levels, at all times. The present invention can be implemented on a partial basis. That is, the present invention encompasses situations in which the machine-guided teaching with student-to-student assistance is used for only some of the students in the school, only at certain times of the day, only on certain days of the week, only certain age or grade levels, to only parts of the curriculum, only certain courses, etc. For example, some of the students in the school may not be taught by a machine-guided curriculum at all, or may be taught by a machine-guided curriculum in a manner other than with the student-to-student assistance described herein (e.g. by a teacher or teaching paraprofessional only).

I claim:

1. A method of educating students, comprising providing educational services to a primary and/or secondary school comprising:
students of mixed-age and/or mixed-grade level;
a curriculum that combines machine-guided teaching with face-to-face teaching; and
wherein a senior student assists a junior students with the machine-guided teaching.

2. The method of claim 1, wherein the school has a school-wide student to certified/licensed teacher ratio of 30 or more.

3. The method of claim 1, wherein the school comprises a teacher who teaches multiple different grade levels.

4. The method of claim 3, wherein the school comprises at least two teachers who teach multiple different grade levels.

5. The method of claim 1, wherein the school comprises a teacher who teaches multiple different subject types.

6. The method of claim 5, wherein the school comprises at least two teachers who teach multiple different subject types.

7. The method of claim 1, wherein the school comprises at least two teachers who teach multiple different subject types and multiple different grade levels.

8. The method of claim 1, wherein at least 70% of the time spent by the senior student in assisting the junior student is not direct teaching of the subject and not participating in collaborative learning of the subject with the junior student.

9. The method of claim 1, wherein the school has only 9 certified/licensed teachers or fewer.

10. The method of claim 1, wherein the school comprises a teaching paraprofessional who is not a certified/licensed teacher.

11. The method of claim 1, wherein the junior student receiving the student-to-student assistance is not higher than 7th grade level and/or not older than 13 years age.

12. The method of claim 1, wherein the junior student receiving the student-to-student assistance is not higher than 7th grade level and/or not older than 13 years age; and the senior student providing the student-to-student assistance is at least 2nd grade level and/or at least 7 years age.

13. The method of claim 1, wherein the school is a charter school.

14. The method of claim 1, wherein the school is located in a zip code, school boundary, or census tract where at least one public school has a mathematics SAT® score in the 75th percentile or below of national or state scores, or less than 85% of the students meet or exceed the state or federal standards for mathematics proficiency.

15. The method of claim 1, wherein the school is located within a zip code having a population density of greater than 1,500 people per square mile.

16. The method of claim 1, wherein the curriculum employs a rotation model in which the junior student rotates through two or more different learning modalities; and wherein at least one, but not all of the different learning modalities uses machine-guided teaching with the student-to-student assistance.

17. The method of claim 1, wherein the school has:
a school-wide student to certified/licensed teacher ratio of 30 or more;
at least two teachers who teach multiple different grade levels; and
at least two teachers who teach multiple different subject types.

18. The method of claim 1, wherein the school has:
only 9 certified/licensed teachers or fewer; and
at least two teachers who teach both multiple different subject types and multiple different grade levels.

19. The method of claim 1, wherein the provision of educational services includes providing online content, hardware, software, electronic media, technical support, books, worksheets, teachers, teacher training, or any combination thereof to the school.

20. A method of providing primary and/or secondary education, comprising:
having students of mixed-age and/or mixed-grade level in a school;
providing to the students a curriculum that combines machine-guided teaching with face-to-face teaching; and
having a senior student assist a junior student with the machine-guided teaching.
